(19) United States
(12) Patent Application Publication
(10) Pub. No.: US 2026/0249949 A1
(43) Pub. Date: Aug. 27, 2026

(54) BICYCLE WITH REAR SUSPENSION AND RELATED COMPENSATING DEVICE OF THE TRAVEL OF SAID SUSPENSION

(71) Applicant: Ochain S.R.L., Varese (IT)

(72) Inventor: Fabrizio Dragoni, Varese (IT)

(73) Assignee: Ochain S.R.L., Varese (IT)

(21) Appl. No.: 18/995,399

(22) PCT Filed: Jul. 21, 2022
(86) PCT No.: PCT/IT2022/000039

§ 371 Date: Jan. 16, 2025

(51) Int. Cl. B62M 6/70; B62J 43/30; B62M 6/45; B62M 9/00

(52) U.S. Cl. CPC B62M 6/70; B62J 43/30; B62M 6/45; B62M 9/00

(57) ABSTRACT

The present invention relates to a bicycle comprising a rear wheel suspension system (12), wherein the crankset (20) and the hub and pinion assembly (22) each comprise at least one gear wheel (26) engaged by said chain and a rotation shaft (44), wherein a compensating device (40) is operatively interposed between the gear wheel and the shaft, the compensating device (40) being positioned to allow an angular compensating stroke (A1) therebetween from a resting position, corresponding to no chain pull, to a compensating position, corresponding to a chain-pulling action generated by the action of the rear suspension, said compensating device (40) comprises two main bodies (46, 48) which are rotatable with respect to each other and integrally with the gear wheel (26) and the shaft (44), respectively, characterised in that a blocking device (60) of their relative motion is operatively interposed between the two main bodies, which relative motion can be selectively activated and deactivated to prevent or allow the compensating stroke.

The present invention relates to a bicycle with rear suspension and related compensating device of the travel of said suspension. The invention is particularly adapted to mountain bikes, however applications to other bicycles with other intended uses or other fields are not excluded.

### BACKGROUND ART

“Full suspended” mountain bikes, i.e. provided with rear suspension, are known in the field of bicycles.

The latter generates a travel of the rear wheel in relation to the frame, with undesirable effects on the drive, in particular a chain pull during compression, such as following a jump or on impact with a bump. This generates a violent rotation of the pedals opposite to the advancement rotation, which destabilizes the rider, up to losing contact with his/her feet. From a mechanical viewpoint, the chain is highly stressed and could end up breaking. The greater the displacement of the wheel with respect to the frame, the greater the effect is felt and is damaging.

It is worth noting that there are travel standards according to the category of use of the bicycle. The travel of the modern MTB (mountain bike) frames goes from a minimum of 80 mm (XC race) to a maximum of 240 mm (downhill race). All the other categories are in the middle.

The problem is particularly felt in the “downhill” categories, i.e. those with travel of the rear suspension from 130/140 mm and up. This does not mean that the problem is not felt also in the other categories. Certainly, the travel indicated may be considered a maximum limit that cannot be overcome with the current technology.

The Applicant has solved the problem by introducing a device that allows rotation between the gear ring and crankset crankarms adapted to compensate for the travel of the shock absorber. This device is described in International Patent Application WO2020194177 and can also be applied to the rear wheel hub.

The Applicant has noted however, that it may be desirable to improve pedalling efficiency and thus reduce or eliminate the perception of empty pedalling following the compensating stroke.

Among other things, this would make compensation more acceptable in sports with greater travel of the rear shock absorber.

The general object of the present invention is to wholly or partly overcome the drawbacks of the prior art.

A preferred object of the present invention is to introduce a compensating system that improves pedalling efficiency.

A further preferable object is to provide a compensating system that is easy and inexpensive to implement.

### GENERAL INTRODUCTION

According to a first general aspect thereof, the present invention relates to a bicycle comprising a frame (5), a rear wheel (10), a suspension system (12) of the rear wheel relative to the frame which allows a predetermined relative displacement (H1) therebetween, a drive system (15) of the motion from a crankset (20) to the rear wheel (10), wherein the drive system (15) comprises a crankset (20) fixed to the frame (5), a hub and pinion assembly (22) fixed to the rear wheel (10), and a drive chain (24) positioned to connect them directly to each other, wherein the crankset (20) and the hub and pinion assembly (22) are subject to reciprocal displacement (H1) by the action of the suspension system, wherein the crankset (20) and the hub and pinion assembly (22) each comprise at least one gear wheel (26) engaged by said chain and a rotation shaft (44), wherein a compensating device (40) is operatively interposed between the gear wheel and the shaft of at least one of said crankset and said hub and pinion assembly, the compensating device (40) being positioned to allow an angular compensating stroke (A1) therebetween from a resting position, corresponding to no chain pull, to a compensating position, corresponding to a chain-pulling action generated by said reciprocal displacement, and vice versa, wherein said compensating stroke is limited to a predetermined angle (A1), said compensating device (40) comprises two main bodies (46, 48) which are rotatable with respect to each other and integrally with the gear wheel (26) and the shaft (44), respectively, characterised in that a blocking device (60) of their relative motion is operatively interposed between the two main bodies, which relative motion can be selectively activated and deactivated to prevent or allow the compensating stroke.

In this way, advantageously the rider can selectively allow the compensating stroke Al when travelling on a trail wherein the need to absorb the stresses of jumps prevails, or can lock it when the need to maximise pedalling performance prevails.

According to some preferred embodiments of the invention, the blocking device (60) locks the main bodies (46, 48) in said resting position.

According to a preferred general feature of the invention, the blocking device (60) can be activated at any position of the compensating stroke and is activated only when the latter reaches the resting position. Advantageously, this makes it easy to compensate for any errors in the rider's synchronisation with respect to the trail.

Preferably, said blocking device (60) comprises at least one pair of engagement elements (70a, 70b) intended to engage with each other to provide the locking and integral to one and the other of the two main bodies (46, 47), respectively, wherein the two engagement elements engage in the resting position, and wherein at least one of the two main bodies (46, 48) is integral with a guide (79) which comes into contact with the engagement element which is integral with the other main body and guides it to the resting position when the blocking device (60) is activated during the compensating stroke (Al) in a different position than the resting position.

According to some preferred embodiments, said engagement elements comprise a pin (70a) and its seat (70b), and wherein said guide comprises a ramp (79), facing the pin, which merges into the seat (70b).

Generally speaking, in all embodiments in which locking occurs in the resting position, it is preferable for the bicycle to include a consent control unit (77) programmed to allow and deny consent to the activation of the blocking device (60) during pedalling, or to terminate it after a predetermined time from the activation command without locking having occurred. This prevents the blocking device (60) from unnecessarily trying to lock the compensating stroke Al, with the risk of causing jamming, breakdowns or using energy.

This is particularly advantageous when the blocking device includes a battery-powered electric actuator (70) and said consent control unit (77) prevents the activation thereof, thereby saving battery power.

Consent is particularly effective and easy to implement in cases where the bicycle includes a pedal-assist system equipped with an electric motor, wherein the consent control unit (77) is in communication with said system to obtain information that pedalling is taking place and consequently, inhibit the blocking device (60).

In general, it is preferable for the control unit to give consent in the absence of pedalling, whereby in the event that the compensating device (40) is not in the resting position due to uneven ground, the guide (79) allows the locking on the first return to that position.

As a preferable general feature, said engagement device (60) comprises at least one actuator (70) that can be activated and deactivated by remote control means (63) positioned on the handlebars.

Advantageously, the rider can stop compensation whenever desired and several times along the same trail, ideally also after each jump. If this is combined with the general feature mentioned above according to which the blocking device (60) can be activated in any position of the compensating stroke and is only activated when the latter reaches the resting position, any of the rider's errors in synchronisation with respect to the trail can be easily compensated for. If there is a consent control unit, it inhibits the activation of the actuator during pedalling.

According to another preferred general feature, said engagement device comprises at least one pin and its seat, which can be selectively engaged with each other to lock and release the relative rotation of the main bodies (46, 48).

Preferably, the compensating device (40) comprises at least one stop element (102) which is integral with one of the two main bodies (46, 48), interposed between a resting end element (104) and a compensating end element (62), which are integral with the other main body, wherein the stop element (102) alternately stops against the end elements (104, 62), thus defining the compensating stroke (Al).

According to some preferred embodiments, between the two main bodies (46, 48) there are operatively interposed recall means towards the resting position, corresponding to a condition of no chain pull, wherein the recall means act for the whole compensating stroke A1.

According to a second general aspect thereof, the present invention relates to a compensating device (40) of the above-mentioned type.

According to a third general aspect thereof, the present invention relates to a crankset (20) and/or a hub and pinion assembly comprising a compensating device of the above-described type.

### DETAILED DESCRIPTION

Further characteristics and advantages of the present invention will become clearer from the following detailed description of the preferred embodiments thereof, with reference to the accompanying drawings and provided by way of indicative and non-limiting example.

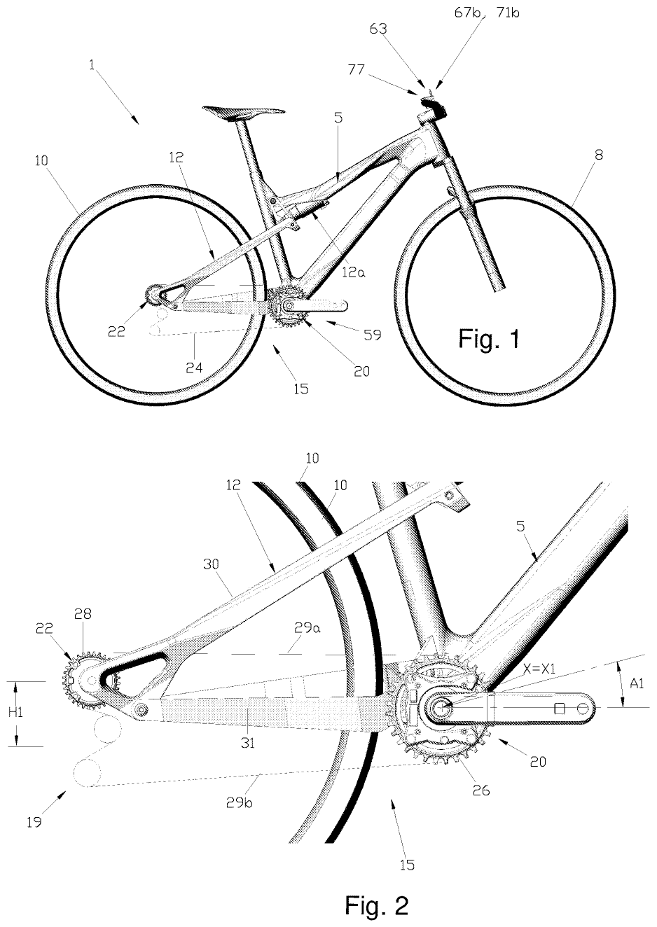

FIG. 1 schematically shows a bicycle according to the present invention;

FIG. 2 shows the detail of the drive system of FIG. 1;

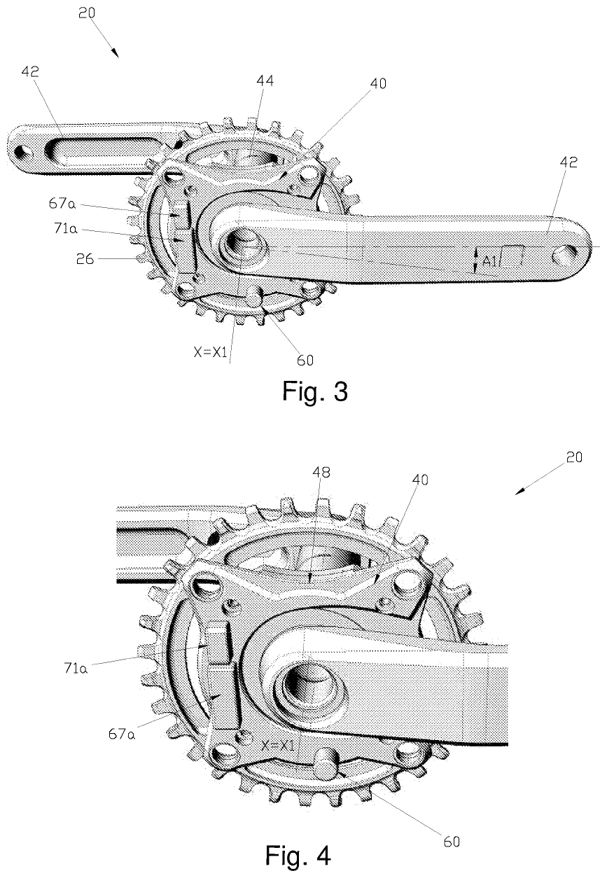

FIG. 3 shows the crankset of the drive system of FIG. 2;

FIG. 4 shows the compensating device of the crankset of FIG. 3;

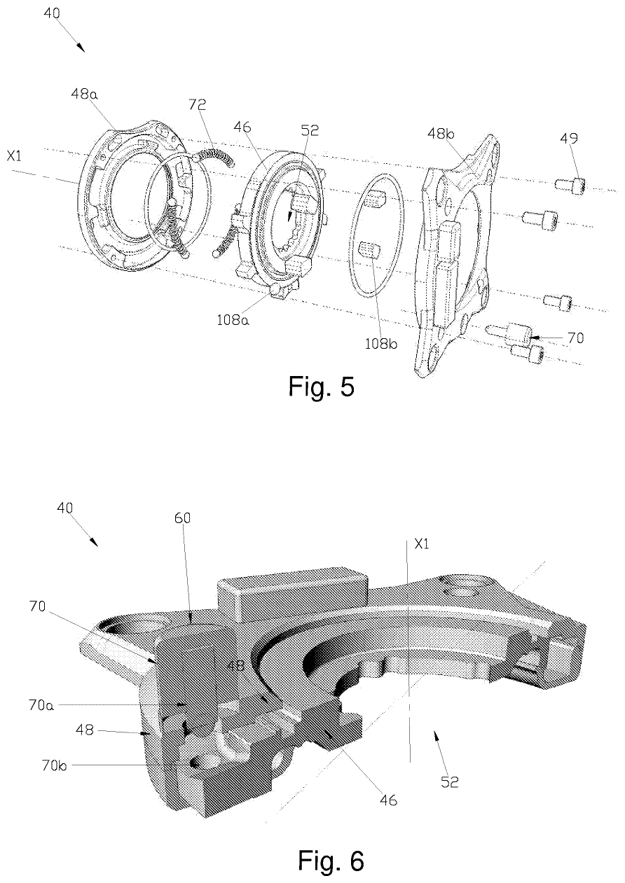

FIGS. 5 and 6 respectively show an exploded view and a section view of the compensating device of FIG. 4;

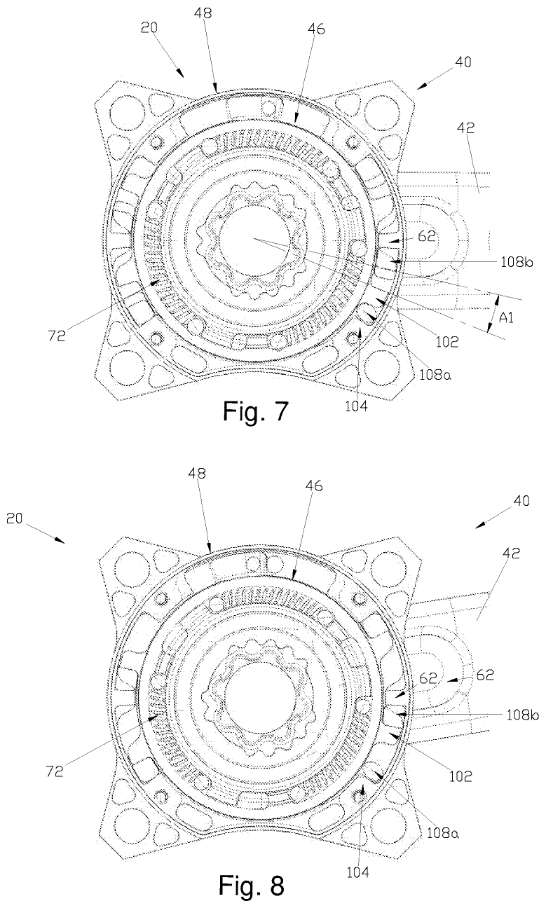

FIGS. 7 and 8 respectively show the resting position and the opposite position of maximum compensation, corresponding to an adjustment allowing a first compensating stroke A1;

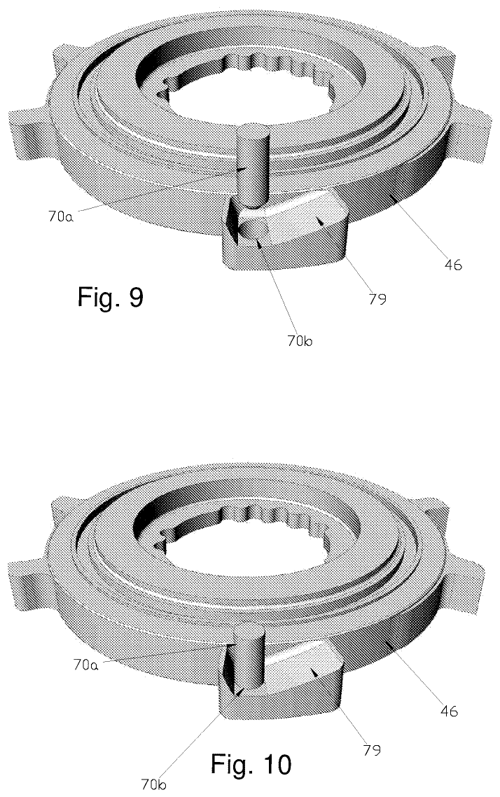

FIG. 9 shows some parts of the blocking device of the previous figures in a released configuration, such as the one of the section in FIG. 6, in which they allow the compensation of the corresponding compensating device to take place; the latter is in a resting position, i.e. no chain-pulling action resulting from pedalling or from travel of the rear wheel suspension system;

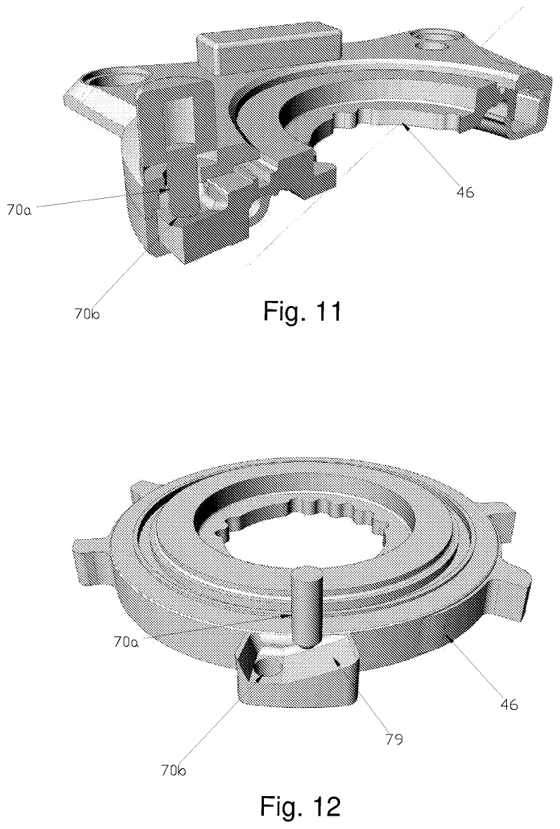

FIGS. 10 and 11 show the parts in FIGS. 6 and 9, respectively, in a locking configuration, in which they prevent the operation of the corresponding compensating device;

FIG. 12 shows the blocking device in the released configuration of FIG. 10, but the compensating device is in an operating position, corresponding to a chain-pulling action resulting from pedalling or travel of the rear wheel suspension system.

FIG. 1 shows a bicycle according to the present invention, indicated as a whole by reference number 1.

Bicycle 1 comprises a frame 5, a front wheel 8, a rear wheel 10, a suspension system 12 of the rear wheel 10, a drive system 15 for putting the rear wheel 10 into rotation by means of a crankset 20 fixed to the frame 5.

The suspension system 12 may be of any applicable type, for example comprise suspension arms 30, 31 (FIG. 2) which are articulated to one another and to the frame to allow a predetermined oscillation of the wheel 10, and comprise oscillation damper means 12a.

In addition to the crankset 20, the drive system 15 also comprises a rear hub and pinion assembly 22 fixed to the wheel 10 and a drive chain 24 which transmits the motion between the two.

During use, the oscillation H1 of the rear wheel 10 results in the oscillation of the hub assembly 22 with respect to the crankset 20 and accordingly, a pull on the chain 24.

The crankset 20 and the rear hub and pinion assembly 22 in particular each comprise at least one gear wheel 26 and 28, and the chain 24 forms a ring with which it engages them, both having two stretches 29a and 29b suspended between said wheels. When the rear wheel 10 oscillates upwards due to a bump or jump, the chain is subjected to pulling. The phenomenon is known with the name “pedal kickback”.

In general, the upper stretch of chain 29a is subjected to pulling, while the lower stretch 29b is slack. This may occur for example, because it in general is preferable for the drive system to comprise a gear 19 with an articulated arm, for example of the traditional type comprising a rocker and cage, oscillating due to elastic suspension which compensates for the pulling stresses on the lower stretch 29b of the chain.

Below we describe a compensating device 40 of the chain pull applied to the crankset 20. That described in reference to the application of the compensating device to the crankset is applicable in a mirror-like manner to the application of the rear wheel to the hub and/or pinions.

With reference to FIG. 3, the crankset 20 comprises a pair of crankarms 42 coupled to a drive shaft 44 that is rotatable about an axis X, to drag the gear wheel 26 into rotation.

The compensating device 40 is operatively interposed between the crankarms and the gear wheel 26.

The compensating device 40 allows a relative rotation A1 of predetermined extent between the crankarms 42 and the gear wheel 26. The extent of Al determines the amount of oscillation H1 that can be compensated for, as well as the extent of empty stroke of the crankarm felt when pedalling is resumed.

The relative rotation A1 is also known as compensating stroke and takes place both in the forward and reverse direction between two ends known as ‘end stops’. In particular, there is a resting end stop end 104, corresponding to no chain pull, and a compensating end stop end 62, corresponding to the position taken on in the presence of the maximum chain pull that can be offset.

Referring to FIGS. 4, 5 and 6, the compensating device 40 comprises a first and a second main body 46, 48 coupled together, which are rotatable with respect to each other about an axis X1.

The first main body 46 comprises an opening 52 with a shape complementary to a profile shaped for the torque transmission of the shaft 44 and such that, in the assembled condition on the crankset 20, the rotation axes X and X1 of the shaft and of the compensating device 40 coincide. The first main body 46 is therefore generally integral in rotation with the shaft and the crankarm 42.

The second main body 48 is a shell comprising the gear ring 26 or a plurality of coupling points 61 to the gear ring 26. The shell 48 preferably is divided into two half-shells 48a and 48b that can be coupled to and uncoupled from each other. The first main body 46 is housed in the second main body 48 in rotatable manner with respect thereto, about axis X of the shaft 44. The first body 46 is retained in the second body 48 when the two half-shells 48a and 48b are sandwiched to each other, for example by means of screws 49.

With reference to FIGS. 7 and 8, the compensating device 40 mounted in the crankset 20 is shown with the half-shell 48a removed for descriptive clarity. The crankset is of the type intended to be mounted on the right side of the bicycle, as seen by an observer riding the bicycle and with reference to the direction of travel.

The device 40 generally comprises means for defining the compensating stroke A1, comprising at least one stop element 102, which is integral with one of the two main bodies 46 and 48, interposed between a pair of end elements 104 and 62 of the compensating stroke A1 which are integral with the other main body. The stop element 102 alternately abuts against the end elements 104 and 62, defining the stroke A1; in general its course is a sector of a circle about the rotation axis X1 of the bodies 46, 48. In particular, as shown in FIG. 7, when the stop element 102 abuts on the end element 104, the compensating device 40 is in the resting position, corresponding to no chain pull, i.e. when the suspension system is extended and the rear wheel is therefore at its maximum travel length H1. For this reason, element 104 is also called the resting end element.

When, as shown in FIG. 8, the stop element 102 is abutting on the end element 62, the device 40 is in its position of maximum compensation, i.e. in the presence of chain pull that caused the main bodies 46 and 48 to rotate with respect to each other by an amount equal to the compensating stroke A1, wherein the chain pull was generated by a travel of the rear wheel that reduced the length H1 with respect to the resting position. For this reason, element 62 is also called the compensating end element.

Respective damper means 108a and 108b are preferably interposed between the stop element 102 and the end elements 104 and 62 to damp the abutment thereof at the respective end of stroke A1. These comprise, for example, one or more bodies made of elastomeric material.

Recall means 72 that keep the compensating device 40 in the resting position, whereby it acts in opposition to the chain pull, are generally interposed between the main bodies 46 and 48. The recall means 72, for example, are elastic and preferably comprise one or more springs, e.g. helical springs, housed in circumferential seats obtained between the two main bodies 46 and 48. Said elastic means 72 are compressed by the relative rotation between the main bodies 46 and 48 during the stroke A1 to go from the resting position to the position of maximum compensation. The recall means 72 are generally overridden to exert their action in every position of the stroke A1.

FIGS. 7 and 8 show the example of a resting position and a compensating position, respectively.

When used downhill and/or in a jump, the rider rests on the pedals with the crankarms 42 arranged horizontally (position of maximum stability). In this position, the compensating device is in the resting condition of FIG. 7 due to the thrust of the recall means 72. When the rear wheel is raised due to an impact, it generates the chain pull which drags the gear wheel 26 into rotation with respect to the crankarms 52 for the stretch of compensating stroke A1, placing the compensating device 40 in the condition of maximum stroke of FIG. 8, or in an intermediate condition, depending on the stress experienced. Such stroke is considered the forward stroke.

When the rider resumes pedalling from the resting position in FIG. 7, the compensating device 40 undergoes the same rotation of forward stroke A1 to the maximum stroke position in FIG. 8.

Having now understood the basic construction and operation of the compensating system 40, we note that it additionally includes a blocking device 60. The blocking device 60 of the illustrated example is electrically operated so that it is part of a blocking system 59 comprising rider-operated control means 63, preferably located on the handlebars of the bicycle and preferably in wireless communication with the blocking device 60, although wired communication is not excluded.

In the wireless case, both the control means 63 and the blocking device 60 include suitable antennas 67a, 67b and batteries 71a, 71b.

As best shown in FIGS. 6 and 9, the blocking device 60 comprises at least one actuator 70, preferably an electric actuator, which can be activated by means of the control means 63 to lock the relative rotation between the two main bodies 46, 48 when they are in the resting position. The actuator is, for example, of linear type and includes, for example, a pin 70a that moves between a locking position and a releasing position. The pin 70a is supported by one of the two main bodies 46, 48 and is capable of engaging a respective release seat 70b which is integral with the other main body 46, 48 when they are in the resting position.

In positions other than the resting position, pin 70a and seat 70b are not aligned with each other and cannot engage with each other. The main body provided with a seat 70b however includes a guide 79 for the pin 70a, which guides it towards the seat 70b during the compensating stroke A1 if the pin is activated. Such a guide is, for example, a ramp 79 inclined towards said seat. In this way, if the blocking device is activated in the presence of uneven ground, it allows the compensating stroke A1 to end, after which it locks the compensating device 40 when it first reaches the resting position.

The control means 63 and the blocking device 60 can also be used to switch from the locked condition to the released condition by simply disengaging the actuator 70 (in the example, by removing the pin 70a from the seat 70b).

In general, we note that the actuator 70 may be of any type, for example electric or hydraulic, although manual operation of the pin is not excluded.

In the case of an electric actuator 70, it is necessary to preserve the battery charge, so it is possible to provide a consent control unit 77 programmed either to prevent activation of the actuator during pedalling or to terminate it after a predetermined time by the activation command without locking having occurred. This consent control unit 77 is particularly useful in the case of a bicycle equipped with a pedal-assist system, as such systems are usually equipped with torque sensors. The consent control unit 77 can, for example, obtain a signal from the pedal-assist system to obtain information that it is active, i.e. pedalling is taking place, and consequently inhibit the locking of the blocking device 60. In fact, if the latter were to attempt to lock the compensating stroke, it would fail to do so as it would not be in the resting position until pedalling has stopped, and as a result the battery connected to the actuator would wear out unnecessarily. If there is no pedal-assist system, it is still possible to provide for the presence of a pedalling sensor, for example, a torque sensor, such as a torque metre, connected to the control unit to provide this information.

The torque metre or pedal-assist system therefore generally acts as a means of information of the consent control unit 77 on the pedalling status to obtain said information that pedalling is taking place.

What is described for the crankset is alternatively reproducible in a hub and pinion assembly.

### GENERAL INTERPRETATION OF TERMS

In understanding the object of the present invention, the term “comprising” and its derivatives, as used herein, are intended as open-ended terms that specify the presence of declared characteristics, elements, components, groups, integers and/or steps, but do not exclude the presence of other undeclared characteristics, elements, components, groups, integers and/or steps. The above also applies to words that have similar meanings such as the terms “comprised”, “have” and their derivatives. Furthermore, when used in the singular, the terms “part”, “section”, “portion”, “member” or “element” can have the double meaning of a single part or a plurality of parts. As used herein to describe the above embodiment(s), the following directional terms “forward”, “backward”, “above”, “under”, “vertical”, “horizontal”, “below” and “transverse”, as well as any other similar directional term, refer to the embodiment described in the operating position. Finally, terms of degree such as “substantially”, “about” and “approximately” as used herein are intended as a reasonable amount of deviation of the modified term such that the final result is not significantly changed.

While only selected embodiments have been chosen to illustrate the present invention, it will be apparent from this description to those skilled in the art that various modifications and variations can be made without departing from the scope of the invention as defined in the appended claims. For example, the sizes, shape, position or orientation of the various components can be modified as needed and/or desired. The components shown which are directly connected or in contact with each other can have intermediate structures arranged between them. The functions of one element can be performed by two and vice versa. The structures and functions of one embodiment can be adopted in another embodiment. Not all the advantages of a particular embodiment have to necessarily be present at the same time. Any characteristic that is original compared to the prior art, alone or in combination with other characteristics, should also be considered a separate description of further inventions by the Applicant, including the structural and/or functional concepts embodied by such characteristics. Therefore, the foregoing descriptions of the embodiments according to the present invention are provided for illustrative purposes only and not for the purpose of limiting the invention as defined by the appended claims and their equivalents.

1. A bicycle comprising a frame, a rear wheel a suspension system of the rear wheel relative to the frame which allows a predetermined relative displacement therebetween, a drive system of the motion from a crankset to the rear wheel wherein the drive system comprises a crankset fixed to the frame a hub and pinion assembly fixed to the rear wheel, and a drive chain positioned to connect them directly to each other, wherein the crankset and the hub and pinion assembly are subject to reciprocal displacement by the action of the suspension system, wherein the crankset and the hub and pinion assembly each comprise at least one gear wheel engaged by said chain and a rotation shaft, wherein a compensating device is operatively interposed between the gear wheel and the shaft of at least one of said crankset and said hub and pinion assembly, the compensating device being positioned to allow an angular compensating stroke therebetween from a resting position, corresponding to no chain pull, to a compensating position, corresponding to a chain-pulling action generated by said reciprocal displacement, and vice versa, wherein said compensating stroke is limited to a predetermined angle, said compensating device comprises two main bodies which are rotatable with respect to each other and integrally to the gear wheel and to the shaft, respectively, characterised in that a blocking device of their relative motion is operatively interposed between the two main bodies, which relative motion can be selectively activated and deactivated to prevent or allow the compensating stroke.

2. A bicycle according to claim 1, characterised in that the blocking device locks the main bodies in said resting position.

3. A bicycle according to claim 2, characterised in that the blocking device can be activated at any position of the compensating stroke and is activated when the latter reaches the resting position.

4. A bicycle according to claim 3, characterised in that said blocking device comprises at least one pair of engagement elements intended to engage with each other to provide the locking and integral to one and the other of the two main bodies respectively, wherein the two engagement elements engage in the resting position, and wherein at least one of the two main bodies is integral with a guide which comes into contact with the engagement element which is integral with the other main body and guides it to the resting position when the blocking device is activated during the compensating stroke.

5. A bicycle according to claim 4, characterised in that said engagement elements comprise a pin and its seat and wherein said guide comprises a ramp, facing the pin, which merges into the seat

6. A bicycle according to claim 2, characterised in that it comprises a consent control unit programmed to allow and deny consent to the activation of the blocking device during pedalling, or to terminate it after a predetermined time from the activation command without the locking having occurred.

7. A bicycle according to claim 6, characterised in that the blocking device comprises an electric actuator powered by a battery, and said consent control unit prevents its activation, thereby saving battery power.

8. A bicycle according to claim 6, characterised in that it comprises a pedal-assist system equipped with an electric motor, wherein the consent control unit is in communication with said system to derive information that pedalling is taking place and consequently, inhibit the blocking device

9. A bicycle according to claim 6, when dependent on 4 or 5, characterised in that the control unit is programmed to give consent in the absence of pedalling, whereby in the event that the compensating device is not in the resting position due to uneven ground, the guide allows the locking on the first return to that position.

10. A bicycle according to claim 1, characterised in that between the two main bodies there are operatively interposed recall means towards the resting position, corresponding to a condition of no chain pull, wherein the recall means act throughout the whole compensating stroke A1.
